(19) United States
(12) Patent Application Publication
(10) Pub. No.: US 2024/0424929 A1
(43) Pub. Date: Dec. 26, 2024

(54) POWER CONVERTER ARRANGEMENT WITH PARTIAL POWER CONVERSION

(71) Applicant: Huawei Digital Power Technologies Co., Ltd., Shenzhen (CN)

(72) Inventors: Eduardo FACANHA DE OLIVEIRA, Munich (DE); Ismael HERRERO AOULAD, Munich (DE); Daniel GAONA, Munich (DE)

(21) Appl. No.: 18/829,392

(22) Filed: Sep. 10, 2024

Related U.S. Application Data
(63) Continuation of application No. PCT/EP2022/056377, filed on Mar. 11, 2022.

(51) Int. Cl. B60L 53/22; H02M 1/44; H02M 3/00; H02M 3/158; H02M 7/162

(52) U.S. Cl. CPC B60L 53/22; H02M 3/01; H02M 3/1582; H02M 7/1626; B60L 2210/30; H02M 1/44

(57) ABSTRACT

The disclosure provides methods and a power converter arrangement for converting an alternating current (AC) voltage into a direct current (DC) voltage. The power converter arrangement includes: an AC-DC conversion stage being configured to convert an AC voltage into a first DC link voltage at a first DC link and into a second DC link voltage at a second DC link; a DC-DC conversion stage connected to the AC-DC conversion stage, the DC-DC conversion stage being configured to provide the DC voltage based on the first DC link voltage and the second DC link voltage; and a partial-power DC-DC converter coupled between the AC-DC conversion stage and the DC-DC conversion stage, the partial-power DC-DC converter being configured to exchange power between the first DC link and the second DC link.

### CROSS-REFERENCE TO RELATED APPLICATIONS

This application is a continuation of International Application No. PCT/EP2022/056377, filed on Mar. 11, 2022, the disclosure of which is hereby incorporated by reference in its entirety.

### TECHNICAL FIELD

The disclosure relates to a power converter arrangement with partial power conversion and a corresponding method. In particular, the disclosure relates to the field of circuit topology for power converters, in particular AC/DC power converters. Specifically, this disclosure relates to an isolated AC/DC converter with partial power conversion for applications such as automotive on-board chargers (OBC), for example, and others.

### BACKGROUND

Some applications, like automotive on-board chargers (OBC), demand galvanic isolation between AC grid input and DC battery output when supplying energy from the grid, with a determined power factor, to a very wide range of output voltages. To fulfill these conditions, the volume, cost, and efficiency of the converter need to be considered and it is a challenge to find an optimal solution. The most common way to achieve this is using a two-stage system, composed of an AC/DC power factor correction (PFC) rectifier and an isolated DC/DC converter (LLC resonant converter, for instance). The PFC stage keeps the DC-link voltage nearly constant around 400V and the isolated DC/DC converter becomes responsible for regulating the output voltage and current using frequency modulation. In this way, the DC/DC's switching frequency needs to be swept within a certain range, depending on the resonant tank parameters.

In this solution, the best performance is achieved for switching frequencies close to the resonant frequency, at which condition the gain is unity. For battery charger application, because of the very wide battery voltage range, if DC-link voltage is constant, the gain range of LLC resonant converter can be very large. To achieve this very wide gain range, switching frequency needs to be varied far from resonant frequency producing a rapid drop in efficiency, mainly due to the higher amount of reactive power being processed by the components. Besides the lower efficiency, the design of the LLC transformer is not optimized, due to the wide frequency range, leading to larger size of its magnetic core.

### SUMMARY

This disclosure provides a solution for a circuitry for a power converter that can be applied for on-board chargers without the above-described disadvantages.

In particular, this disclosure presents a solution for providing a compact and highly efficient power conversion arrangement for AC-DC power conversion.

The foregoing and other objects are achieved by the features of the independent claims. Further implementation forms are apparent from the dependent claims, the description and the figures.

The disclosure presents a novel topology for a power conversion arrangement comprising a 5-level rectifier with two distinct variable DC-links for power factor correction (PFC), followed by a partial-power DC/DC converter to provide output voltage regulation and by an isolated DC/DC converter to provide galvanic isolation between input and output, as shown in FIGS. 1a and 1b.

The disclosed rectifier comprises two distinct DC-links having different voltage levels and, depending on the phase angle of the input voltage sine wave, the converter will select the one that best matches the required output voltage levels, increasing with this the modulation index and the converter efficiency.

The voltage levels of the two DC-links can be regulated according to the required output voltage. The sum of these voltages can be kept proportional to the output voltage. This function can be performed by an additional partial-power DC/DC converter that exchanges power between the two DC-links. Since most of the power can be transferred directly from the PFC to the isolated DC/DC converter, the additional DC/DC converter can be designed for only a very small portion of the nominal power.

Since the two DC-link voltages can be regulated according to the required output voltage, voltage and current regulation functionality is no longer a requirement for the isolated DC/DC converter stage. Due to its high efficiency and compact size, a series resonant converter (SRC) operating with fixed frequency (at its resonance frequency) is preferred over a frequency-modulated LLC, being adopted for only galvanic isolation purposes, without any regulation functionality.

According to embodiments of this disclosure, one of the two primary legs of the full-bridge SRC can be connected to the first DC-link capacitor C₁, while the other one can be connected to the second DC-link capacitor C₂, as shown in FIG. 3a. The different voltages across each leg of an isolated converter would normally cause the transformer to have a DC component, which would lead to saturation of the magnetic core. However, adopting a series resonant converter for this function can easily solve this problem. This is because its series resonant capacitor can block the DC component across the resonant tank. In this way, the voltage across the transformer's magnetizing inductor behaves like in a standard isolated circuit having an equivalent DC-link voltage of (V_{C}_{₁}+V_{C}_{₂})/2.

In turn, the partial-power DC/DC converter can regulate the second DC-link voltage V_{C}_{₂}, so that the equivalent DC-link voltage (V_{C}_{₁}+V_{C}_{₂})/2 can be regulated proportionally to the output voltage V_{C}_{₂}, considering the transformer's turns-ratio n. Since there exist direct paths for the current to flow from the two PFC rectifier output ports to the two SRC input ports, the partial-power DC/DC converter may handle only the power difference that may exist in the input-output ports nodes, meaning that the additional DC/DC converter can be designed for only a small portion of the nominal power.

As a result, the series resonant converter may be used only for galvanic isolation purposes and can work at a fixed switching frequency equal to its resonant frequency, with unity gain independently upon the output load. If necessary, the output voltage V_{C}_{₃} can be further reduced (down to zero) through duty cycle modulation of the isolated resonant converter, for instance.

The presented novel power conversion technique can enhance overall OBC performance by using optimized converters for rectification and isolation. It doesn't only solve the issue of the reduced efficiency due to the low modulation index, but it also improves the efficiency in comparison to conventional PFC rectifiers with fixed DC-link voltage. Since both DC-link voltages can be kept below 450 V, devices with a voltage-class of 650 V or even lower can be used.

In order to describe the disclosure in detail, the following terms, abbreviations and notations will be used:
OBC On-board Charger
PFC Power Factor Correction
DC Direct Current
AC Alternating Current
ZVS Zero Voltage Switching
PWM Pulse Width Modulation
EMC Electro-Magnetic Compatibility
LLC Filter network with two inductances L and one capacitance C
CLLC Filter network with two inductances L and two capacitances C
SRC Series Resonant Converter

In this disclosure, converters, i.e., power converters and power electronics converters are described. Power converters are applied for converting electric energy from one form to another, such as converting between AC and DC or between DC and DC, e.g., between high or medium voltage DC and low voltage DC. Power converter can also change the voltage or frequency or some combination of these. Power electronics converters are based on power electronics switches that can be actively controlled by applying ON/OFF logic (i.e., PWM operation, usually commanded by a closed loop control algorithm).

In this disclosure, PFC (power factor correction) and PFC rectifiers are described. Power factor correction shapes the input current of off-line power supplies to maximize the real power available from the mains. Ideally, the electrical appliance should present a load that emulates a pure resistor, in which case the reactive power drawn by the device is zero. Inherent in this scenario is the absence of input current harmonics, i.e., the current is a perfect replica of the input voltage, usually a sine wave, and is exactly in phase with it. In this case the current drawn from the mains is at a minimum for the real power required to perform the needed work, and this minimizes losses and costs associated not only with the distribution of the power, but also with the generation of the power and the equipment involved in the process. Power factor correction is defined as the ratio of real power to apparent power, where the real power is the average, over a cycle, of the instantaneous product of current and voltage, and the apparent power is the product of the rms value of current times the rms value of voltage. If both current and voltage are sinusoidal and in phase, the power factor is 1.0. If both are sinusoidal but not in phase, the power factor is the cosine of the phase angle.

According to a first aspect, the disclosure relates to a power converter arrangement for converting an alternating current, AC, voltage into a direct current, DC, voltage, the power converter arrangement comprising: an AC-DC conversion stage being configured to convert an AC voltage into a first DC link voltage at a first DC link and into a second DC link voltage at a second DC link; a DC-DC conversion stage connected to the AC-DC conversion stage, the DC-DC conversion stage being configured to provide the DC voltage based on the first DC link voltage and the second DC link voltage; and a partial-power DC-DC converter coupled between the AC-DC conversion stage and the DC-DC conversion stage, the partial-power DC-DC converter being configured to exchange power between the first DC link and the second DC link.

This means that power is exchanged between the first DC link and the second DC link.

Such a power converter arrangement provides the advantage of a compact and highly efficient conversion device for AC-DC power conversion.

The power converter arrangement can be advantageously applied in a voltage converter circuit adopting an isolated DC-DC resonant converter, such as a SRC operating at fixed frequency at the resonance. In particular for battery charger applications operating in a very wide battery voltage range, the power converter arrangement can operate at high system efficiency. Due to the design of the power converter arrangement, the size of the magnetic core can be reduced, and also the weight of the OBC.

The required voltage across the output of the power converter arrangement, i.e., the above-mentioned DC voltage, can be a DC voltage set by an operator of the device, e.g., a DC voltage selected by the operator from one or more predefined DC voltage values. Alternatively, the required voltage across the output of the power conversion arrangement, i.e., the above DC voltage, can be a battery voltage of a battery connected to the power converter arrangement, e.g., a nominal voltage required by the battery. For example, the required output voltage can be connected to the output of the DC-DC conversion stage.

In an exemplary implementation of the power converter arrangement, the partial-power DC-DC converter is configured to regulate a value of the second DC link voltage so that an equivalent DC link voltage is proportional to a predetermined value of the DC voltage, wherein the equivalent DC link voltage corresponds to a half of the sum of a value of the first DC link voltage and the value of the second DC link voltage.

Due to this characteristic of the power converter arrangement, the partial-power DC-DC converter handles only the power difference that may exist in the input-output ports nodes, meaning that the partial-power DC-DC converter can be designed for only a small portion of the nominal power. Thus, the component size of the power converter arrangement can be reduced.

In an exemplary implementation of the power converter arrangement, the DC-DC conversion stage comprises a transformer having a Turns Ratio; wherein the value of the DC voltage corresponds to the equivalent DC link voltage divided by the Turns Ratio of the transformer.

This provides the advantage that the conversion relation of the power converter arrangement can be flexible adjusted depending on the design (i.e., turns ratio) of the transformer.

In an exemplary implementation of the power converter arrangement, the DC-DC conversion stage comprises a Series Resonant Converter configured to operate at a fixed switching frequency equal to its resonant frequency.

The galvanic isolation can be implemented by means of the series resonant converter (SRC) working at resonant frequency instead of a frequency modulated CLLC. This offers the following advantages: a) open-loop operation without requiring any complex control; b) higher efficiency over the entire voltage range; c) simpler synchronous rectification, since secondary is always in phase with primary; d) smaller optimized transformer due to lower reactive power circulation; and e) resonant tank is only required on the primary side, due to good transformer coupling.

In an exemplary implementation of the power converter arrangement, the AC-DC conversion stage comprises a first port for providing the first DC link voltage and a second port for providing the second DC link voltage; wherein the DC-DC conversion stage comprises a first port directly connected to the first port of the AC-DC conversion stage, and a second port directly connected to the second port of the AC-DC conversion stage.

This direct connection of the two ports of the AC-DC conversion stage with the two ports of the DC-DC conversion stage is responsible for the advantage that the partial-power DC-DC converter can handle only the power difference that may exist in the input-output port nodes, meaning that the additional (i.e., partial power) DC-DC converter can be designed for only a small portion of the nominal power.

In an exemplary implementation of the power converter arrangement, the DC-DC conversion stage comprises a third port for providing the DC voltage, wherein the third port of the DC-DC conversion stage is galvanically isolated from the first port and the second port of the DC-DC conversion stage.

This provides the advantage that safety requirements with respect to isolation of medium or high voltage part and low voltage part can be fulfilled. Furthermore, since the two DC-link voltages can be regulated according to the required output voltage, the isolated DC-DC converter is only used for galvanic isolation purposes, without any regulation functionality. However, if necessary, the output voltage can be further reduced (down to zero) through duty cycle modulation of the isolated resonant converter, for instance.

In an exemplary implementation of the power converter arrangement, the partial-power DC-DC converter is configured to process a power difference between a first average power and a second average power, the first average power being a power provided by the AC-DC conversion stage to one of the first or second ports of the AC-DC conversion stage, and the second average power being a power demanded by the DC-DC conversion stage from the respective port of the AC-DC conversion stage.

This provides the advantage that, as a consequence, the power flowing through the partial-power DC-DC converter can be only a portion of the rated power depending on the operating point.

The lower the difference between the powers provided to and demanded from each DC-link, the lower the amount of power that needs to be processed by the partial-power DC-DC converter. Based on that, the designed voltage levels on each DC-link can be optimized, especially the second DC-link voltage. It is noteworthy that having the second DC-link voltage below a certain value (for instance, 300 V) allows the adoption of the corresponding leg of the SRC in a neutral-point clamped configuration comprising semiconductor devices with lower voltage class (200 V, for instance). Such devices are cheaper, more efficient, and smaller than standard 650 V devices.

In an exemplary implementation of the power converter arrangement, the partial-power DC-DC converter comprises a first port connected to the first port of the AC-DC conversion stage and the first port of the DC-DC conversion stage; and the partial-power DC-DC converter comprises a second port connected to the second port of the AC-DC conversion stage and the second port of the DC-DC conversion stage.

This provides the advantage that the partial-power DC-DC converter can be interconnected between the AC-DC conversion stage and the DC-DC conversion stage for efficiently regulating the first and second DC link voltages.

In an exemplary implementation of the power converter arrangement, the power converter arrangement comprises: a reference node providing a common reference potential, wherein the first port and the second port of the AC-DC conversion stage are coupled to the reference node; wherein the first port and the second port of the DC-DC conversion stage are coupled to the reference node; and wherein the first port and the second port of the partial-power DC-DC converter are coupled to the reference node.

This provides the advantage of a common reference (or ground) potential for both terminals of the AC-DC conversion stage and for both terminals of the DC-DC conversion stage. Such common reference potential allows to reduce the design complexity of the power conversion arrangement.

In an exemplary implementation of the power converter arrangement, the power converter arrangement comprises: a first capacitor coupled between the first port of the AC-DC conversion stage and the reference node, wherein the first DC link voltage corresponds to a voltage across the first capacitor; and a second capacitor coupled between the second port of the AC-DC conversion stage and the reference node, wherein the second DC link voltage corresponds to a voltage across the second capacitor.

This provides the advantage that a first configuration of two (or more) possible configurations which is a common ground (i.e., reference node) capacitors configuration can be efficiently implemented by this implementation.

In an exemplary implementation of the power converter arrangement, the power converter arrangement comprises: a first capacitor coupled between the first port and the second port of the AC-DC conversion stage, wherein the first DC link voltage corresponds to a voltage across the first capacitor; and a second capacitor coupled between the second port of the AC-DC conversion stage and the reference node, wherein the second DC link voltage corresponds to a voltage across the second capacitor.

This provides the advantage that a second configuration of two (or more) possible configurations which is a split DC-link (i.e., reference node) capacitors configuration can be efficiently realized by this implementation.

In an exemplary implementation of the power converter arrangement, the DC-DC conversion stage comprises: a full-bridge inverter, the full-bridge inverter comprising a first inverter leg connected between the first port of the AC-DC conversion stage and the reference node, and a second inverter leg connected between the second port of the AC-DC conversion stage and the reference node.

Such a full-bridge inverter design allows efficient coupling of the two ports of the DC-DC conversion stage to the transformer for implementing galvanic isolation.

If the duty cycles of all switches are symmetric which is the case here, it is an intrinsic characteristic of the circuit (i.e., the power converter arrangement) that a current flowing through the first inverter leg is equal to a current flowing through the second inverter leg.

According to a second aspect, the disclosure relates to an automotive battery charging device comprising the power converter arrangement of the first aspect.

This provides the advantage that the automotive battery charging device can be implemented in a high-efficient manner.

According to a third aspect, the disclosure relates to a method for converting an alternating current, AC, voltage into a direct current, DC, voltage, the method comprising: converting an AC voltage into a first DC link voltage at a first DC link and into a second DC link voltage at a second DC link, by an AC-DC conversion stage; providing a DC voltage, by a DC-DC conversion stage, based on the first DC link voltage and the second DC link voltage; and exchanging power between the first DC link and the second DC link by a partial-power DC-DC converter, coupled between the AC-DC conversion stage and the DC-DC conversion stage.

Such a method provides the same advantages as the power conversion arrangement described above. I.e., such a method provides highly efficient conversion between AC and DC at compact component sizes.

The method for power conversion can be advantageously applied in a voltage converter circuit adopting an isolated DC-DC resonant converter, such as a SRC operating at fixed frequency at the resonance. In particular, for battery charger applications operating in a very wide battery voltage range, the method can result in an operation at high system efficiency.

According to a fourth aspect, the disclosure relates to a computer program product including computer executable code or computer executable instructions that, when executed, causes at least one computer to execute the method according to the third aspect described above.

The computer program product may run on a controller or a processor for controlling the above-described power conversion arrangement.

According to a fifth aspect, the disclosure relates to a computer-readable medium, storing instructions that, when executed by a computer, cause the computer to execute the method according to the third aspect described above. Such a computer readable medium may be a non-transient readable storage medium. The instructions stored on the computer-readable medium may be executed by a controller or a processor.

A main application for the technology described in this disclosure is on-board chargers for electric vehicles, which require high power density, a very wide voltage operation range due to the battery characteristics, galvanic isolation between grid and battery output, and low cost. All these are issues that are addressed by this disclosure and where the presented solution performs better than current market solutions.

The introduced solution presented herein combines the advantages of having DC-link voltages below 450 V (so that the use of 650 V semiconductors or even less is feasible) and of using a fixed-frequency DC/DC resonant converter (with optimized transformer size and reduced losses), without requiring a further full power conversion stage. In summary, the advantages of the presented solution in comparison to the current solutions are the following: 1) Use of SRC working at resonant frequency instead of frequency-modulated CLLC; 1a) Higher efficiency over the entire voltage range; 1b) Smaller (optimized) transformer with lower reactive power circulation; 1c) Lower DC side EMC filter effort; 2) 5-level PFC (fₛ<150 kHz) with variable DC-link voltages, allowing lower switching voltages for the semiconductors; 2a) Higher efficiency; 2b) Lower ripple current and THD, with similar AC choke size; 2c) Lower AC side EMC filter effort; 3) Lower semiconductor cost albeit higher performance.

### BRIEF DESCRIPTION OF THE DRAWINGS

Further embodiments of the disclosure will be described with respect to the following figures, in which:

FIG. 1a shows a circuit diagram of a power converter arrangement 100 according to a first embodiment;

FIG. 1b shows a circuit diagram of a power converter arrangement 200 according to a second embodiment;

FIG. 2 shows schematic diagrams 10, 20 illustrating the principle of voltage conversion when using a single positive voltage level V_{c1} (10) and when using two positive voltage levels V_{c1} and V_{c2} (20) according to the first and second embodiments;

FIG. 3a shows another circuit diagram of a power converter arrangement 300 according to the first embodiment;

FIG. 3b shows another circuit diagram of a power converter arrangement 400 according to the second embodiment;

FIG. 4a shows another circuit diagram of a power converter arrangement 500 according to the first embodiment;

FIG. 4b shows another circuit diagram of a power converter arrangement 600 according to the first embodiment;

FIG. 5 shows a performance diagram illustrating an example of the power provided by the AC-DC conversion stage to the two DC-links with respect to the second DC-link voltage V_{c2};

FIG. 6 shows a performance diagram illustrating an example of DC-link voltage levels with respect to the required output voltage;

FIG. 7a shows a performance diagram illustrating an example of the power provided by the PFC to the DC-links with respect to the output voltage V_{c3};

FIG. 7b shows a performance diagram illustrating an example of the power processed by the partial-power DC-DC converter with respect to the output voltage V_{c3}; and

FIG. 8 shows a schematic diagram illustrating a method 800 for converting an AC voltage into a DC voltage according to the disclosure.

### DETAILED DESCRIPTION OF EMBODIMENTS

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the disclosure. The following detailed description, therefore, is not to be taken in a limiting sense, and the scope of the disclosure is defined by the appended claims.

It is understood that comments made in connection with a described method may also hold true for a corresponding device or system configured to perform the method and vice versa. For example, if a specific method step is described, a corresponding device may include a unit to perform the described method step, even if such unit is not explicitly described or illustrated in the figures. Further, it is understood that the features of the various exemplary aspects described herein may be combined with each other, unless specifically noted otherwise.

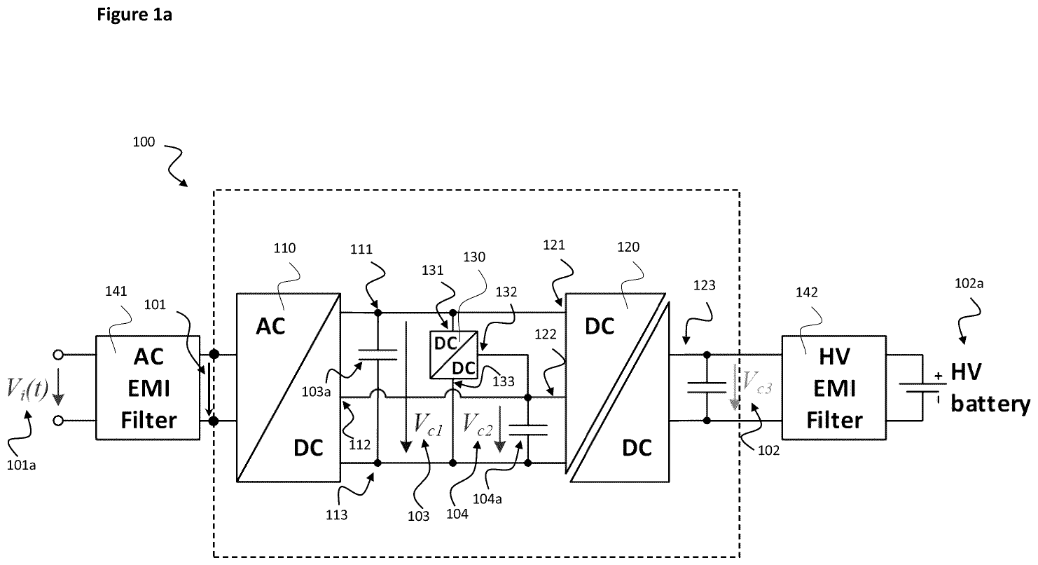

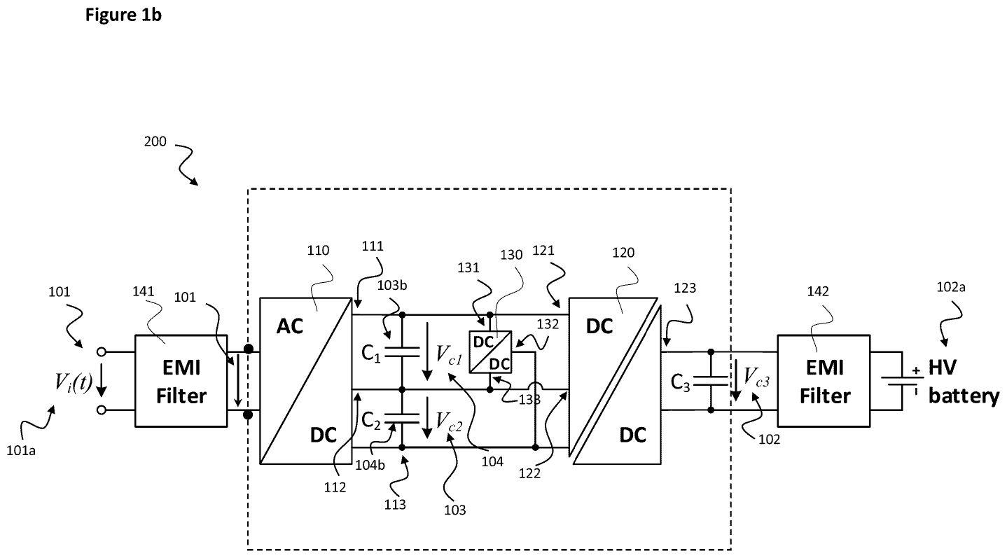

The structure of the novel power converter arrangement 100, 200 is depicted in FIGS. 1a and 1b. The power converter arrangement 100, 200 comprises an AC-DC conversion stage 110, a DC-DC conversion stage 120 and a partial-power DC-DC converter 130 in between. The AC-DC conversion stage 110, e.g., implemented as a 5-level rectifier, with two distinct variable DC-links for power factor correction is followed by the partial-power DC-DC converter 130 to provide output voltage regulation and by the isolated DC-DC conversion stage 120 to provide galvanic isolation between input and output.

The partial-power DC/DC converter 130 is needed for exchanging power between the two DC-links. Most of the power can be transferred directly from the PFC stage, i.e., AC-DC conversion stage 110, to the isolated DC/DC conversion stage 120 without needing to be processed by the partial-power DC/DC converter 130. Since the two DC-link voltages can be regulated according to the required output voltage, the isolated DC/DC conversion stage 120 can be preferably adopted for only galvanic isolation purposes, without any regulation functionality.

FIG. 1a shows a circuit diagram of a power converter arrangement 100 according to a first embodiment.

The power converter arrangement 100 for converting an AC voltage 101 into a DC voltage 102 comprises an AC-DC conversion stage 110, a DC-DC conversion stage 120 and a partial-power DC-DC converter 130 coupled between the AC-DC conversion stage 110 and the DC-DC conversion stage 120.

The AC-DC conversion stage 110 is configured to convert an AC voltage 101 into a first DC link voltage 103 at a first DC link and into a second DC link voltage 104 at a second DC link.

The DC-DC conversion stage 120 is connected to the AC-DC conversion stage 110 and is configured to provide the DC voltage 102 based on the first DC link voltage 103 and the second DC link voltage 104.

The partial-power DC-DC converter 130 is configured to exchange power between the first DC link and the second DC link.

The partial-power DC-DC converter 130 may be configured to regulate a value of the second DC link voltage 104 so that an equivalent DC link voltage is proportional to a predetermined value of the DC voltage 102. The equivalent DC link voltage corresponds to a half of the sum of a value of the first DC link voltage 103 and the value of the second DC link voltage 104.

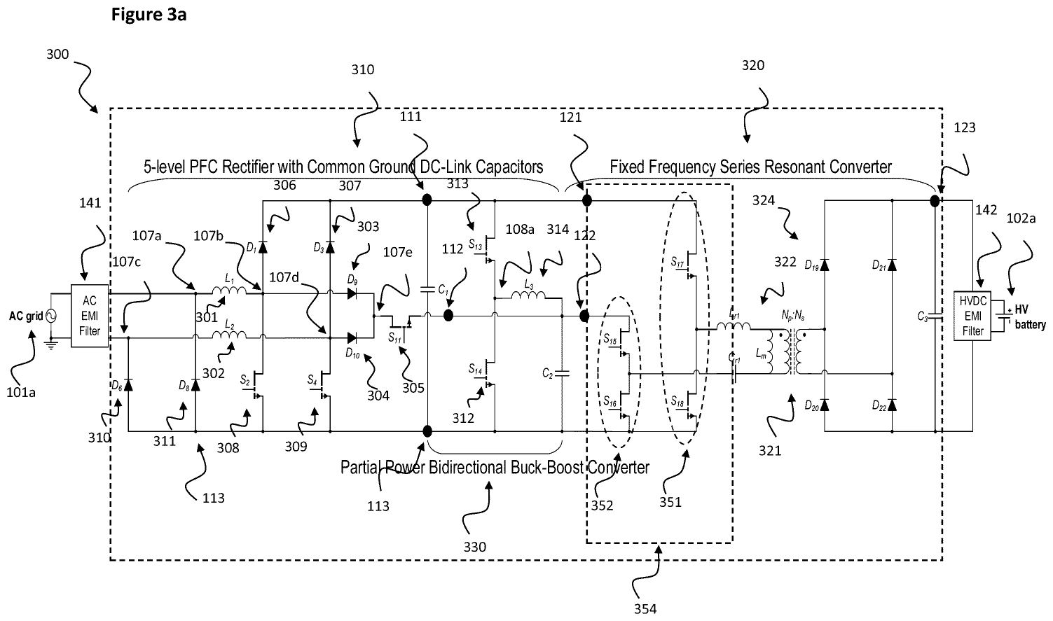

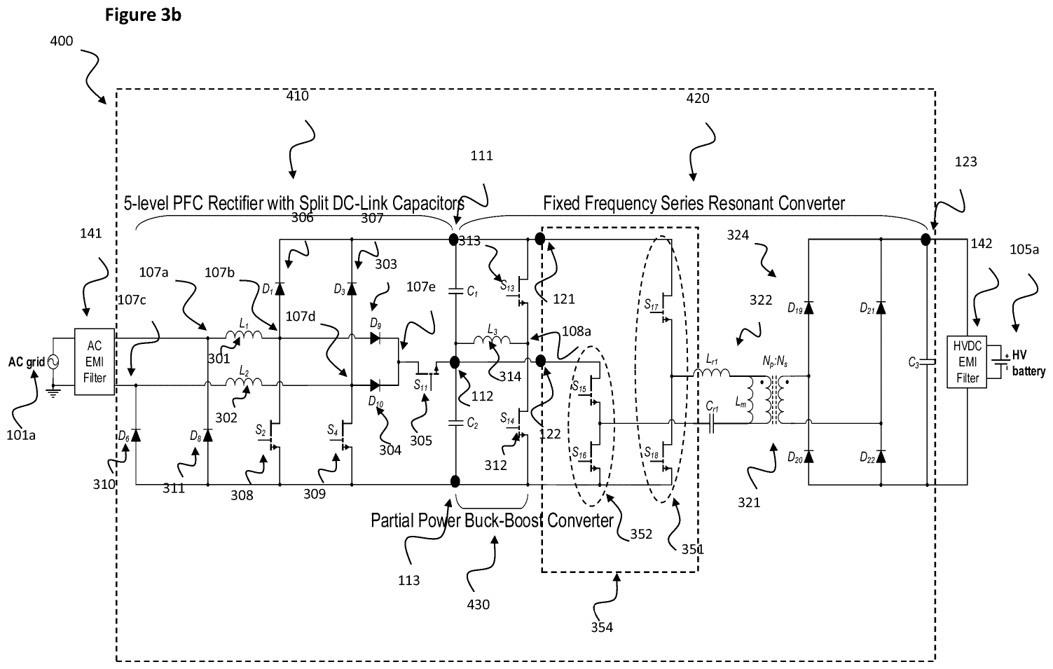

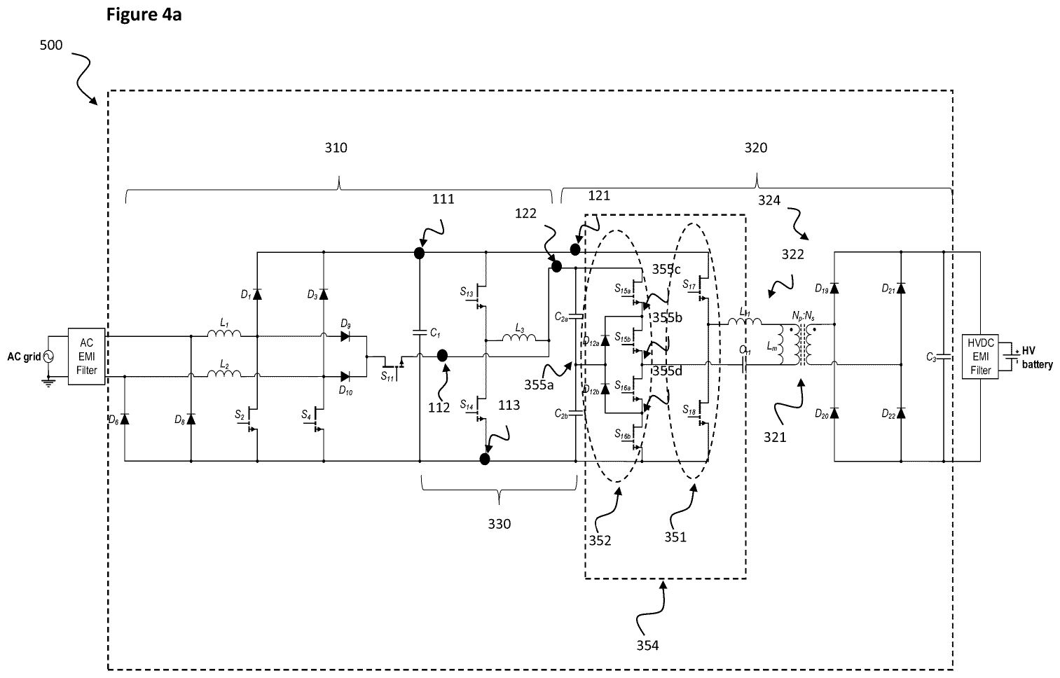

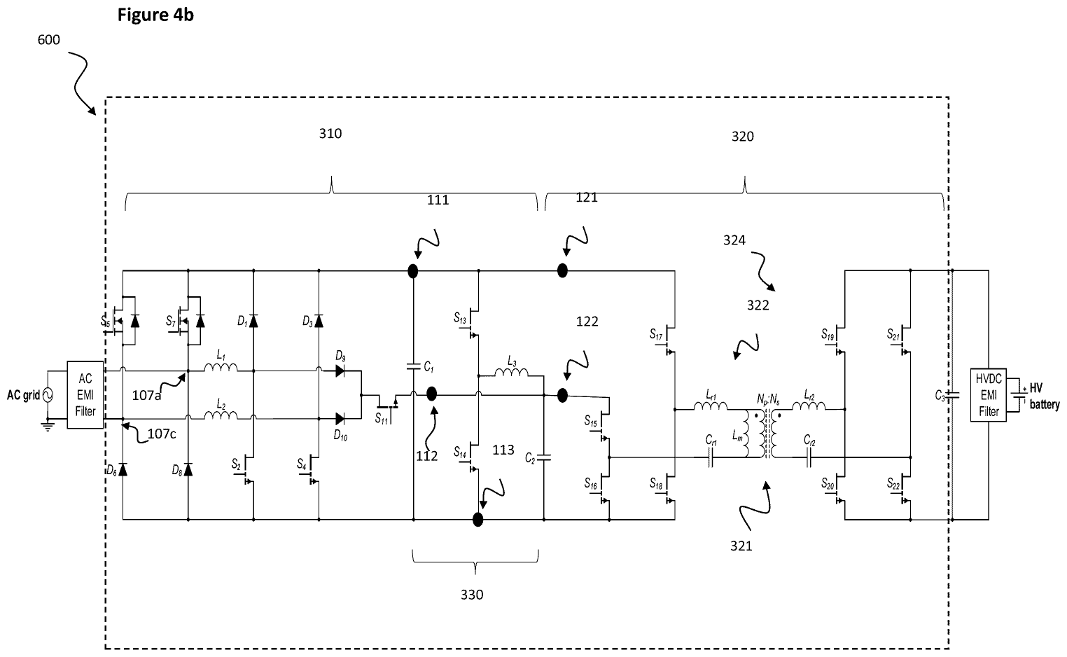

The DC-DC conversion stage 120 may comprise a transformer 321, e.g., as illustrated in FIGS. 3a, 3b, 4a and 4b, having a Turns Ratio. The value of the DC voltage 102 may correspond to the equivalent DC link voltage divided by the Turns Ratio of the transformer 321.

The DC-DC conversion stage 120 may comprise a Series Resonant Converter 320, 420, 520, 620, e.g., as illustrated in FIGS. 3a, 3b, 4a and 4b, configured to operate at a fixed switching frequency equal to its resonant frequency.

The AC-DC conversion stage 110 may comprise a first port 111 for providing the first DC link voltage 103 at the first DC link and a second port 112 for providing the second DC link voltage 104 at the second DC link.

The DC-DC conversion stage 120 may comprise a first port 121 directly connected to the first port 111 of the AC-DC conversion stage 110, and a second port 122 directly connected to the second port 112 of the AC-DC conversion stage 110.

The DC-DC conversion stage 120 may comprise a third port 123 for providing the DC voltage 102 at the output of the power conversion arrangement 100 which corresponds to the output of the DC-DC conversion stage 120. The third port 123 of the DC-DC conversion stage 120 is galvanically isolated from the first port 121 and the second port 122 of the DC-DC conversion stage 120.

The partial-power DC-DC converter 130 may be configured to process a power difference between a first average power and a second average power. The first average power corresponds to a power provided by the AC-DC conversion stage 110 to one of the first or second ports 111, 112 of the AC-DC conversion stage 110. The second average power corresponds to a power demanded by the DC-DC conversion stage 120 from the respective port 111, 112 of the AC-DC conversion stage 110.

The partial-power DC-DC converter 130 may comprise a first port 131 connected to the first port 111 of the AC-DC conversion stage 110 and the first port (121) of the DC-DC conversion stage 120. The partial-power DC-DC converter 130 may comprise a second port 132 connected to the second port 112 of the AC-DC conversion stage 110 and the second port 122 of the DC-DC conversion stage 120.

The power converter arrangement 100 may comprise a reference node 113 providing a common reference potential. The first port 111 and the second port 112 of the AC-DC conversion stage 110 may be coupled to the reference node 113. The first port 121 and the second port 122 of the DC-DC conversion stage 120 may be coupled to the reference node 113. The first port 131 and the second port 132 of the partial-power DC-DC converter 130 may be coupled to the reference node 113.

In the first embodiment shown in FIG. 1a, the power converter arrangement 100 comprises a first capacitor 103a coupled between the first port 111 of the AC-DC conversion stage 110 and the reference node 113, wherein the first DC link voltage 103 corresponds to a voltage across the first capacitor 103a. The power converter arrangement 100 further comprises a second capacitor 104a coupled between the second port 112 of the AC-DC conversion stage 110 and the reference node 113, wherein the second DC link voltage 104 corresponds to a voltage across the second capacitor 104a.

In this first embodiment, both capacitors 103a, 104a are implemented as common-ground capacitors or common-reference capacitors, respectively, where the potential of the reference node 113 may correspond to the ground potential.

The DC-DC conversion stage 120 may comprise a full-bridge inverter 354, e.g., as shown in FIGS. 3a and 3b. The full-bridge inverter 354 may comprise a first inverter leg 351 connected between the first port 111 of the AC-DC conversion stage 110 and the reference node 113, and a second inverter leg 352 connected between the second port 112 of the AC-DC conversion stage 110 and the reference node 113.

The power conversion arrangement 100 may be coupled on its input side via an AC electromagnetic interference, EMI, filter 141 to an AC input terminal for receiving the AC voltage Vi(t) 101a. This AC EMI filter 141 is configured to suppress electromagnetic interference from the AC voltage 101 at the input of the AC-DC conversion stage 110.

The power conversion arrangement 100 may be coupled on its output side via a DC EMI filter 142 to a battery, e.g., High Voltage battery 102a. The DC EMI filter 142 is configured to suppress electromagnetic interference from the DC voltage 102 provided at the output 123 of the DC-DC conversion stage 120.

Both filters, AC EMI filter 141 and DC EMI filter 142 are optional components of the power conversion arrangement 100.

The power converter arrangement 100 may be used for implementing an automotive battery charging device (not shown in the Figures) for charging a battery of a vehicle.

FIG. 1b shows a circuit diagram of a power converter arrangement 200 according to a second embodiment.

The power converter arrangement 200 is similar to the power converter arrangement 100 according to the first embodiment described above with respect to FIG. 1a. However, the circuit configuration of the partial power DC-DC converter 130 is different and the capacitors 103a, 104a shown in FIG. 1a are different, here in FIG. 1b referred to as capacitors 103b, 104b, which are connected differently as described in the following.

The power converter arrangement 200 for converting an AC voltage 101 into a DC voltage 102 comprises an AC-DC conversion stage 110, a DC-DC conversion stage 120 and a partial-power DC-DC converter 130 coupled between the AC-DC conversion stage 110 and the DC-DC conversion stage 120.

The AC-DC conversion stage 110 is configured to convert an AC voltage 101 into a first DC link voltage 103 at a first DC link and into a second DC link voltage 104 at a second DC link.

The DC-DC conversion stage 120 is connected to the AC-DC conversion stage 110 and is configured to provide the DC voltage 102 based on the first DC link voltage 103 and the second DC link voltage 104.

The partial-power DC-DC converter 130 is configured to exchange power between the first DC link and the second DC link.

The AC-DC conversion stage 110 may be implemented as a 5-level PFC rectifier with split DC-link capacitors as described in the following. The partial-power DC-DC converter 130 may be implemented as a partial power buck-boost converter, e.g., as described below with respect to FIGS. 3a, 3b, 4a and 4b. The DC-DC conversion stage 120 may be implemented as a fixed frequency series resonant converter.

The power converter arrangement 200 comprises a first capacitor 103b coupled between the first port 111 and the second port 112 of the AC-DC conversion stage 110, wherein the first DC link voltage 103 corresponds to a voltage across the first capacitor 120b.

The power converter arrangement 200 comprises a second capacitor 104b coupled between the second port 112 of the AC-DC conversion stage 110 and the reference node 113, wherein the second DC link voltage 104 corresponds to a voltage across the second capacitor 104b.

This interconnection of the two capacitors 103b, 104b in the power converter arrangement 200 is also referred to as split DC-link capacitors configuration.

The other functionalities described above with respect to FIG. 1a, beside the two capacitors 103a, 104a and their interconnection, is equal for the second embodiment depicted in FIG. 1b.

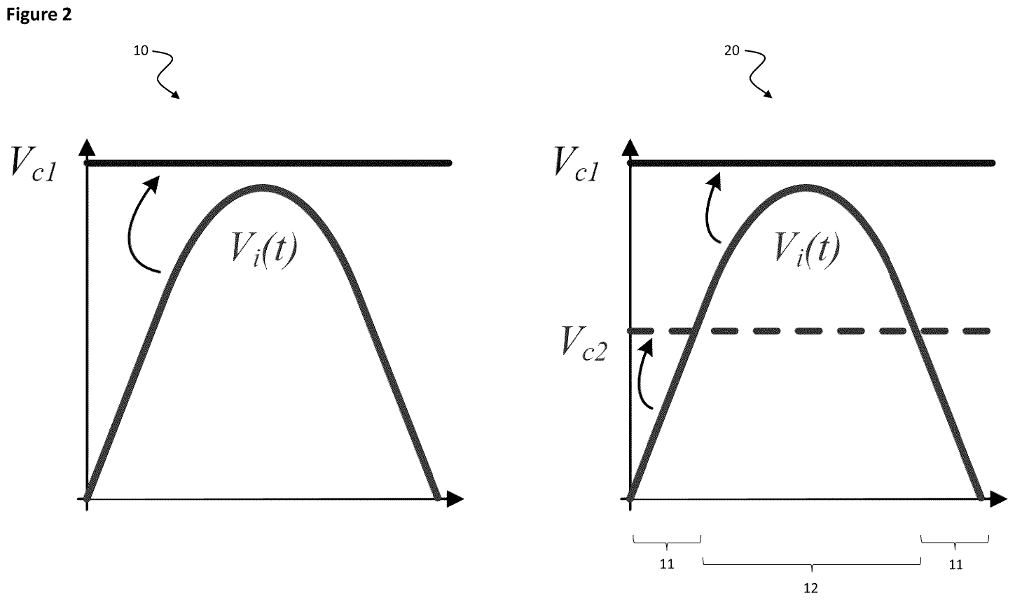

FIG. 2 shows schematic diagrams 10, 20 illustrating the principle of voltage conversion when using a single positive voltage level V_{c1} (10) and when using two positive voltage levels V_{c1} and V_{c2} (20) according to the first and second embodiments.

The power conversion circuit 100, 200 presented above with respect to FIGS. 1a and 1b my comprise a 5-level rectifier (the AC-DC conversion stage 110) used for power factor correction (PFC), followed by a partial-power DC/DC converter 130 that provides output voltage regulation, and by an isolated DC/DC converter (the DC-DC conversion stage 120) ensuring galvanic isolation between input and output. Due to its high efficiency and compact size, a full-bridge series resonant converter (SRC) operating at its resonant frequency can be used as a preferred option for the isolated DC/DC stage 120.

The adopted 5-level PFC rectifier 110 (the AC-DC conversion stage 110) presents two distinct variable DC-links having different voltage levels V_{c1} and V_{c2} as shown in the right-hand side diagram 20 of FIG. 2. Depending on the phase angle of the sine wave, the converter will select the one that best matches the required output voltage levels, increasing with this the modulation index and the converter efficiency, as shown in FIG. 2.

The additional voltage levels reduce the switching voltages on the semiconductor devices, diminishing this way losses and stresses on these components. Moreover, the current ripple in the AC inductor is narrowed, resulting in a volume reduction of the required input EMI filter 141 shown in FIGS. 1a and 1b as well.

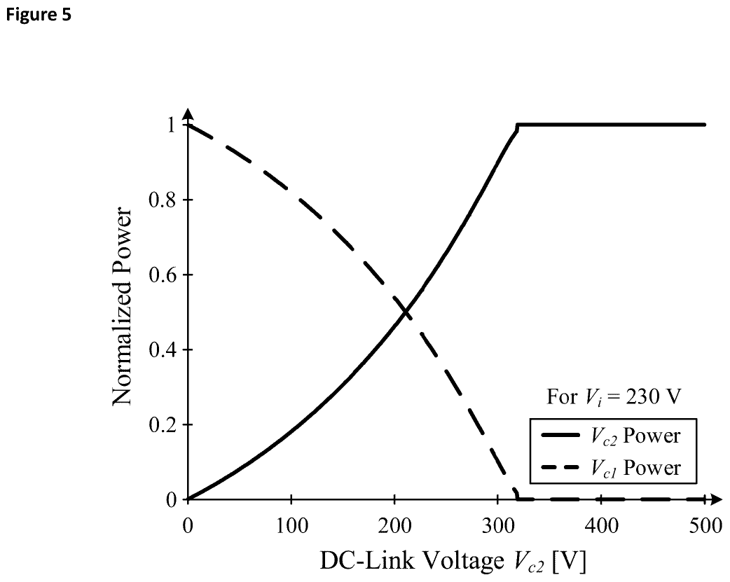

The first DC-link voltage V_{C}_{₁} can be controlled to any voltage above the grid peak voltage (preferably between 400 V and 450 V), while the second DC-link voltage V_{C}_{₂} can assume any value between 0 and V_{C}_{₁}. The higher the value of V_{C}_{₂}, the higher the amount of power flowing to the second DC-link. Full power will be transferred to it if V_{C}_{₂} is equal to or higher than the peak of the AC voltage as shown in FIG. 2 and also in FIG. 5 described below.

The arrangement with variable DC-link voltage allows adoption of a high efficient and compact fixed frequency SRC, instead of a frequency modulated CLLC resonant converter. In the conventional way (see left-hand diagram 10), voltage conversion is performed by using a single positive voltage level V_{c1} while the first 100 and second 200 embodiments described above with respect to FIGS. 1a and 1b apply voltage conversion by using two positive voltage levels V_{c1} and V_{c2} (see right-hand diagram 20).

Unlike the conventional method, the novel power conversion arrangement according to the disclosure can present both DC-links below 450 V, for example, requiring the use of 650 V devices. Moreover, the presented solutions not only solve the issue with the reduced efficiency due to the low modulation index, but also improve it in comparison to conventional PFC rectifiers with fixed DC-link voltage of 400 V. This solution comprises two distinct DC-links having different voltage levels and depending on the phase angle of the sine wave 11, 12 (see right-hand diagram 20), the converter will select the one out of the available DC-links that best matches the required output voltage levels, increasing therefore the modulation index and the converter efficiency as shown in FIG. 2.

FIG. 3a shows another circuit diagram of a power converter arrangement 300 according to the first embodiment.

The power converter arrangement 300 corresponds to the power converter arrangement 100 according to the first embodiment shown in FIG. 1a. But in FIG. 3a circuit details of the AC-DC conversion stage 110, the partial power DC-DC converter 130 and the DC-DC conversion stage 120 are shown.

The basic structure of the first embodiment of the power conversion arrangement 300 as shown in FIG. 3a comprises a 5-level PFC rectifier 310 with common ground (or common reference potential) DC-link capacitors C₁ and C₂, a partial-power bidirectional buck-boost converter 330, and a fixed frequency series resonant converter (SRC) 320, as presented in detail in FIG. 3a.

The AC-DC conversion stage 110, here in FIG. 3a the 5-level PFC rectifier 310, comprises the following components: an inductor L1, 301, coupled between a first internal node 107a and a second internal node 107b; an inductor L2, 302, coupled between a third internal node 107c and a fourth internal node 107d; a diode D9, 303, coupled between the second internal node 107b and a fifth internal node 107e; a diode D10, 304, coupled between the fourth internal node 107d and the fifth internal node 107e; a switch S11, 305, placed between the fifth internal node 107e and the second port 112 of the 5-level PFC rectifier 310; a diode D1, 306, coupled between the second internal node 107b and the first port 111 of the 5-level PFC rectifier 310; a diode D3, 307, coupled between the fourth internal node 107d and the first port 111 of the 5-level PFC rectifier 310; a switch S2, 308, placed between the second internal node 107b and the reference node 113 (i.e., common ground); a switch S4, 309, placed between the fourth internal node 107d and the reference node 113; a diode D6, 310, coupled between the reference node 113 and the third internal node 107c; and a diode D8, 311, coupled between the reference node 113 and the first internal node 107a.

The DC-link capacitor C₁ is connected between the first port 111 of the 5-level PFC rectifier 410 (corresponding to the first port 121 of the SRC 420) and reference node 113 which is common to the 5-level PFC rectifier 410 and the SRC 420. The DC link capacitor C₂ is connected between the second port 112 of the 5-level PFC rectifier 410 (corresponding to the second port 122 of the SRC 420) and the reference node 113.

The partial power DC-DC converter 130, here in FIG. 3a the partial power bidirectional buck-boost converter 330, comprises an internal node 108a connecting a switch S13, 313, an inductor L3, 314, and a switch S14, 312. The inductor L3, 314, is connected to the second port 122 of the DC-DC conversion stage 120, here in FIG. 3a the fixed frequency SRC 320. The switch S13, 313 is connected to both, the first port 111 of the 5-level PFC rectifier 310 and the first port 121 of the SRC 320. The first port 111 of the 5-level PFC rectifier 310 and the first port 121 of the SRC 320 are directly connected to each other. The switch S14, 312 is connected to the reference node 113 which is a common reference node of the 5-level PFC rectifier 310, the partial-power bidirectional buck-boost converter 330 and the SRC 320.

As described above, the power conversion arrangement 300 comprises an output 123 for providing the DC voltage 102 based on the first DC link voltage 103 across DC-link capacitor C₁ and the second DC link voltage 104 across DC-link capacitor C₂, as an isolated output voltage.

The DC-DC conversion stage 120, i.e., the SRC 320 in FIG. 3a, may be configured to operate in an open-loop mode without providing any regulation to the isolated output voltage 102, or in a closed-loop mode providing regulation to the isolated output voltage 102.

The DC-DC conversion stage 120, i.e., the SRC 320 in FIG. 3a, comprises an isolated DC-DC converter having a primary side 322 and a secondary side 324 coupled via a transformer 321. The primary side 322 comprises a resonance circuit with circuit elements Cᵣ₁, Lₘ and Lᵣ₁ which are connected in series. The resonance circuit is connected to an H-bridge 354 with a first leg 351 comprising of switches S17 and S18 and a second leg 352 comprising of switches S15 and S16. The first leg 351 is connected between the first port 121 of SRC 320 (corresponding to the first port 111 of the 5-level PFC rectifier 310) and the reference node 113 while the second leg 352 is connected between the second port 122 of SRC 320 (corresponding to the second port 112 of the 5-level PFC rectifier 310) and the reference node 113.

An AC EMI filter 141 and a HVDC EMI filter 142 is used as described above with respect to FIGS. 1a and 1b.

The first embodiment has the advantage of presenting low losses on the partial-power DC-DC converter 130, 330. A highly efficient and simple Buck converter or Buck-Boost converter 330 can be adopted here.

FIG. 3b shows another circuit diagram of a power converter arrangement 400 according to the second embodiment.

The power converter arrangement 400 corresponds to the power converter arrangement 200 according to the second embodiment shown in FIG. 1b. But in FIG. 3b circuit details of the AC-DC conversion stage 110, the partial power DC-DC converter 130 and the DC-DC conversion stage 120 are shown.

The basic structure of the second embodiment of the power conversion arrangement 400 as shown in FIG. 3b comprises a 5-level PFC rectifier 410 with split DC-link capacitors C₁ and C₂, a partial-power bidirectional buck-boost converter 430, and a fixed frequency series resonant converter (SRC) 420, as presented in detail in FIG. 3b.

The AC-DC conversion stage 110, here in FIG. 3b the 5-level PFC rectifier 410 corresponds to the 5-level PFC rectifier 310 described above with respect to FIG. 3a, i.e., it comprises the following components: an inductor L1, 301, coupled between a first internal node 107a and a second internal node 107b; an inductor L2, 302, coupled between a third internal node 107c and a fourth internal node 107d; a diode D9, 303, coupled between the second internal node 107b and a fifth internal node 107e; a diode D10, 304, coupled between the fourth internal node 107d and the fifth internal node 107e; a switch S11, 305, placed between the fifth internal node 107e and the second port 112 of the 5-level PFC rectifier 310; a diode D1, 306, coupled between the second internal node 107b and the first port 111 of the 5-level PFC rectifier 310; a diode D3, 307, coupled between the fourth internal node 107d and the first port 111 of the 5-level PFC rectifier 310; a switch S2, 308, placed between the second internal node 107b and the reference node 113 (i.e., common ground); a switch S4, 309, placed between the fourth internal node 107d and the reference node 113; a diode D6, 310, coupled between the reference node 113 and the third internal node 107c; and a diode D8, 311, coupled between the reference node 113 and the first internal node 107a.

The DC-link capacitor C₁ is connected between the first port 111 of the 5-level PFC rectifier 410 (corresponding to the first port 121 of the SRC 420) and the second port 112 of the 5-level PFC rectifier 410 (corresponding to the second port 122 of the SRC 420). The DC link capacitor C₂ is connected between the second port 112 of the 5-level PFC rectifier 410 (corresponding to the second port 122 of the SRC 420) and the reference node 113 which is common to the 5-level PFC rectifier 410 and the SRC 420.

The partial power DC-DC converter 130, here in FIG. 3b the partial power bidirectional buck-boost converter 430, comprises an internal node 108a connecting a switch S13, 313, an inductor L3, 314, and a switch S14, 312. The inductor L3, 314, is connected to the second port 112 of the AC-DC conversion stage 110, here in FIG. 3b the 5-level PFC rectifier 410. The switch S13, 313 is connected to both, the first port 111 of the 5-level PFC rectifier 410 and the first port 121 of the SRC 420. The first port 111 of the 5-level PFC rectifier 410 and the first port 121 of the SRC 420 are directly connected to each other. The switch S14, 312 is connected to the reference node 113 which is a common reference node of the 5-level PFC rectifier 410, the partial-power bidirectional buck-boost converter 430 and the SRC 420.

As described above, the power conversion arrangement 400 comprises an output 123 for providing the DC voltage 102 based on the first DC link voltage 103 across DC-link capacitor C₁ and the second DC link voltage 104 across DC-link capacitor C₂, as an isolated output voltage.

The DC-DC conversion stage 120, i.e., the SRC 420 in FIG. 3b, may be configured to operate in an open-loop mode without providing any regulation to the isolated output voltage 102, or in a closed-loop mode providing regulation to the isolated output voltage 102.

As described above with respect to FIG. 3a, the DC-DC conversion stage 120, i.e., the SRC 420 in FIG. 3b, comprises an isolated DC-DC converter having a primary side 322 and a secondary side 324 coupled via a transformer 321. The primary side 322 comprises a resonance circuit with circuit elements Cᵣ₁, Lₘ and Lᵣ₁ which are connected in series. The resonance circuit is connected to an H-bridge 354 with a first leg 351 comprising of switches S17 and S18 and a second leg 352 comprising of switches S15 and S16. The first leg 351 is connected between the first port 121 of SRC 420 (corresponding to the first port 111 of the 5-level PFC rectifier 410) and the reference node 113 while the second leg 352 is connected between the second port 122 of SRC 420 (corresponding to the second port 112 of the 5-level PFC rectifier 410) and the reference node 113.

An AC EMI filter 141 and a HVDC EMI filter 142 is used as described above with respect to FIGS. 1a and 1b.

The second embodiment has the advantage of presenting lower voltage across the DC-link capacitor C₁ when compared to the first embodiment, enabling the use of a lower voltage class device.

FIG. 4a shows another circuit diagram of a power converter arrangement 500 according to the first embodiment.

The circuit structure of the power converter arrangement 500 corresponds to the circuit structure of the power converter arrangement 300 shown in FIG. 3a. However, the circuit structure of the SRC 320, in particular of the second leg 352 of the H-bridge 354 is different.

The DC-link capacitor C₂ is implemented by a series circuit of two DC-link capacitors C₂a and C₂b which are coupled by an intermediate node 355a.

The DC-DC conversion stage 120, i.e., the SRC 320 in FIG. 4a, comprises an isolated DC-DC converter having a primary side 322 and a secondary side 324 coupled via a transformer 321. The primary side 322 comprises a resonance circuit with circuit elements Cᵣ₁, Lₘ and Lᵣ₁ which are connected in series. The resonance circuit is connected to an H-bridge 354 with a first leg 351 comprising of switches S17 and S18 and a second leg 352 comprising of switches S15a, S15b, S16a and S16b. The first leg 351 is connected between the first port 121 of SRC 320 (corresponding to the first port 111 of the 5-level PFC rectifier 310) and the reference node 113 while the second leg 352 is connected between the second port 122 of SRC 320 (corresponding to the second port 112 of the 5-level PFC rectifier 310) and the reference node 113.

The switches S15a, S15b, S16a and S16b of the second leg 352 are connected in series to form together with diodes D12a and D12b a neutral-point clamped configuration. Diode D12a is connected between intermediate node 355a and intermediate node 355c; Diode D12b is connected between intermediate node 355d and intermediate node 355a; switch S15a is connected between intermediate node 355c and second port 122 of SRC 320; switch S15b is connected between intermediate node 355c and intermediate node 355b which is connected to the series resonant circuit; switch S16a is connected between intermediate node 355b and intermediate node 355d; switch S16b is connected between intermediate node 355d and reference node 113.

Having the second DC-link voltage V_{C}² below a certain value (for instance, 300 V) allows the adoption of the corresponding leg of the SRC connect to it in a neutral-point clamped configuration comprising semiconductor devices with lower voltage class (200 V, for instance). Such devices are cheaper, more efficient, and smaller than standard 650 V devices.

FIG. 4b shows another circuit diagram of a power converter arrangement 600 according to the first embodiment.

The circuit structure of the power converter arrangement 600 corresponds to the circuit structure of the power converter arrangement 300 shown in FIG. 3a. However, the circuit structures of the PFC 310 and the SRC 320, in particular of the secondary side 324 of the isolated DC-DC converter are different. Instead of an H-bridge using diodes D19, D20, D21, D22 on the secondary side 324, an H-bridge using switches S19, S20, S21, S22 is implemented.

Then, the power converter arrangement 600 can be configured to enable power transfer in both directions. This bidirectionality can be achieved in different ways, being the most usual by only replacing all diodes with switches as shown in FIG. 4b.

Specifically for the PFC, another option is a modification by adding two low-frequency switches S5, S7 to the original circuit, as depicted in FIG. 4b. Switch S5 is connected between node 107c and the first port 111 of the PFC 310, while switch S7 is connected between node 107a and the first port 111 of the PFC 310,

The use of a symmetric resonant tank on the SRC is optional.

FIG. 5 shows a performance diagram illustrating an example of the power provided by the AC-DC conversion stage to the two DC-links with respect to the second DC-link voltage V_{c2}.

The first DC-link voltage V_{C}_{₁} can be controlled to any voltage above the grid peak voltage (preferably between 400 V and 450 V), while the second DC-link voltage V_{C}_{₂} can assume any value between 0 and V_{C}_{₁}. The higher the value of V_{C}_{₂}, the higher the amount of power flowing to the second DC-link. Full power will be transferred to it if V_{C}_{₂} is equal to or higher than the peak of the AC voltage as shown above in FIG. 2 and here in FIG. 5.

In the solution according to the disclosure, one of the two primary legs of the full-bridge SRC 120 can be connected to the first DC-link capacitor C₁, while the other one can be connected to the second DC-link capacitor C₂, as exemplarily illustrated in FIGS. 3a and 3b. The different voltages across each leg of an isolated converter would normally cause the transformer to have a DC component, which would lead to saturation of the magnetic core. However, adopting a series resonant converter for this function can easily solve this problem. This is because its series resonant capacitor (see Cᵣ₁ in FIGS. 3a, 3b, 4a, 4b) can block the DC component across the resonant tank. In this way, the voltage across the transformer's magnetizing inductor behaves like in a standard isolated circuit having an equivalent DC-link voltage of (V_{C}_{₁}+V_{C}_{₂})/2.

In turn, the partial-power DC/DC converter (see 130 in FIGS. 1a and 1b) regulates the second DC-link voltage V_{C}_{₂}, so that the equivalent DC-link voltage (V_{C}_{₁}+V_{C}_{₂})/2 is regulated proportionally to the output voltage V_{C}_{₃}, considering the transformer's turns-ratio n. If the switching frequency of the SRC 120 is kept constant at its resonant frequency (with unity gain) and the bridge switches with a duty cycle of 0.5, the output voltage V_{C}_{₃} is the average value of both DC-link voltages divided by the transformer turns ratio:

$$\\ {V}_{{C}_{3}} = \frac{{V}_{{C}_{1}} + {V}_{{C}_{2}}}{2 n}$$

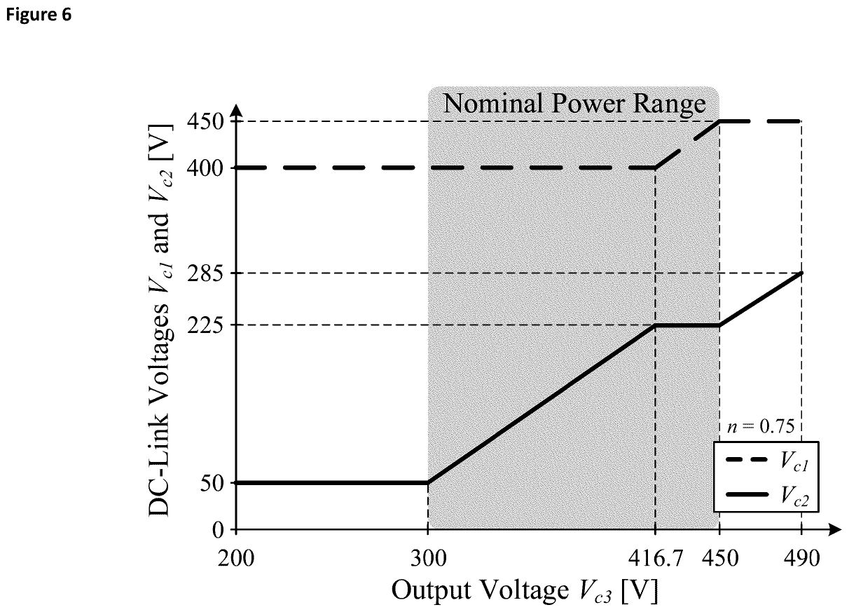

Since there exist direct paths for the current to flow from the two PFC rectifier output ports (see 111, 112 in FIGS. 1a and 1b) to the two SRC input ports (see 121, 122 in FIGS. 1a and 1b), the partial-power DC/DC converter 130 can handle only the power difference that may exist in the input-output ports nodes, meaning that the partial-power DC/DC converter 130 can be designed for only a small portion of the nominal power. To better understand the principle of operation, a functional example is provided wherein the DC-link voltages V_{C}_{₁} and V_{C}_{₂} are defined as a function of the output voltage V_{C}_{₃} as depicted in FIG. 6, resulting in an output voltage range between 200 V and 490 V with a transformer turns ratio n of 0.75.

FIG. 6 shows a performance diagram illustrating an example of DC-link voltage levels with respect to the required output voltage.

As described above, FIG. 6 shows a functional example wherein the DC-link voltages V_{C}_{₁} and V_{C}_{₂} are defined as a function of the output voltage V_{C}_{₃}, resulting in an output voltage range between 200 V and 490 V with a transformer turns ratio n of 0.75 as shown in FIG. 6.

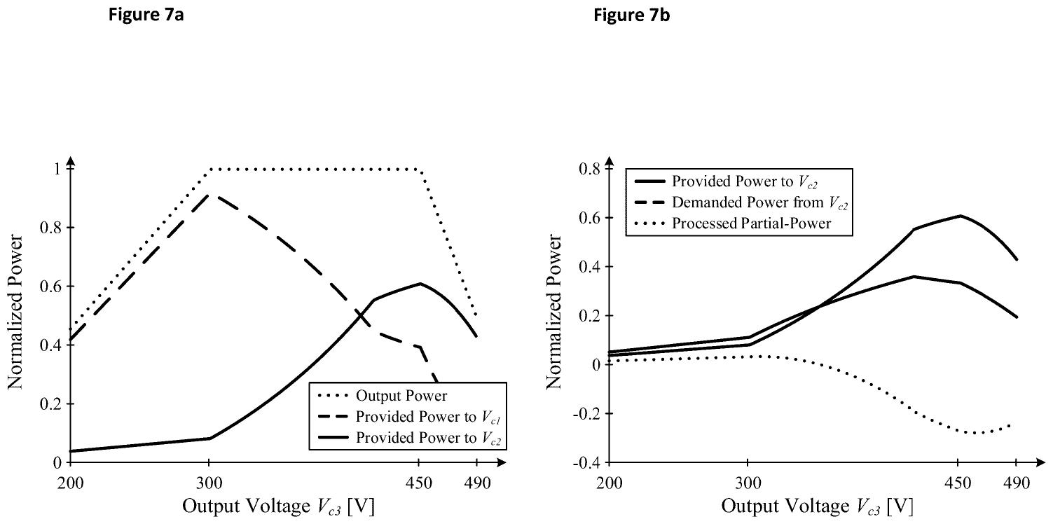

FIG. 7a shows a performance diagram illustrating an example of the power provided by the PFC to the DC-links with respect to the output voltage V_{c3} and FIG. 7b shows a performance diagram illustrating an example of the power processed by the partial-power DC-DC converter with respect to the output voltage V_{c3}.

Following the voltages illustrated in FIG. 6, the power flowing directly from PFC (110 in FIGS. 1a and 1b) to each DC-link is represented in FIG. 7a and depends solely on the second DC-link voltage. The power processed by the partial-power converter 130 is the difference between the power provided by the PFC 110 to one of the DC-links and the power demanded by the SRC 130 from that DC-link, as depicted in FIG. 7b with the second DC-link as reference. As a consequence, for this example, the power flowing through the partial-power DC/DC converter 130 ranges from 0% to 28% of the rated power depending on the operating point.

The lower the difference between the powers provided to and demanded from each DC-link, the lower the amount of power that needs to be processed by the partial-power DC/DC converter 130. Based on that, the designed voltage levels on each DC-link can be optimized, especially the second DC-link voltage V_{C}_{₂}. It is noteworthy that having the second DC-link voltage V_{C}_{₂} below a certain value (for instance, 300 V) allows the adoption of the corresponding leg of the SRC 130 in a neutral-point clamped configuration comprising semiconductor devices with lower voltage class (200 V, for instance), e.g., as shown in FIG. 4a. Such devices are cheaper, more efficient, and smaller than standard 650 V devices.

Furthermore, since the two DC-link voltages can be regulated according to the required output voltage, the isolated DC/DC converter 130 can be only used for galvanic isolation purposes, without any regulation functionality. However, if necessary, the output voltage V_{C}_{₃} can be further reduced (down to zero) through duty cycle modulation of the isolated resonant converter 130, for instance.

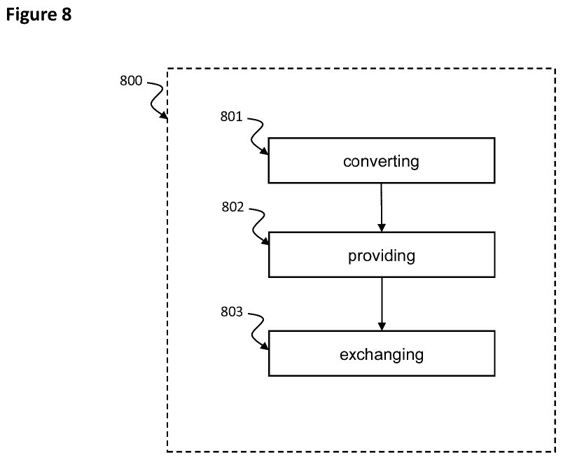

FIG. 8 shows a schematic diagram illustrating a method 800 for converting an AC voltage into a DC voltage according to the disclosure.

The method 800 can be used for converting an AC voltage 101 into a DC voltage 102, e.g., as described above with respect to FIGS. 1a to 7b.

The method 800 comprises converting 801 an AC voltage 101 into a first DC link voltage 103 at a first DC link and into a second DC link voltage 104 at a second DC link, by an AC-DC conversion stage 110, e.g., as described above with respect to FIGS. 1a to 4b.

The method 800 comprises providing 802 a DC voltage 102, by a DC-DC conversion stage 120, based on the first DC link voltage 103 and the second DC link voltage 104, e.g., as described above with respect to FIGS. 1a to 7b.

The method 800 comprises exchanging 803 power between the first DC link and the second DC link by a partial-power DC-DC converter 130, coupled between the AC-DC conversion stage 110 and the DC-DC conversion stage 120, e.g., as described above with respect to FIGS. 1a to 7b.

While a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Also, the terms “exemplary”, “for example” and “e.g.” are merely meant as an example, rather than the best or optimal. The terms “coupled” and “connected”, along with derivatives may have been used. It should be understood that these terms may have been used to indicate that two elements cooperate or interact with each other regardless whether they are in direct physical or electrical contact, or they are not in direct contact with each other.

Although specific aspects have been illustrated and described herein, it will be appreciated by those of ordinary skill in the art that a variety of alternate and/or equivalent implementations may be substituted for the specific aspects shown and described without departing from the scope of the disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

Many alternatives, modifications, and variations will be apparent to those skilled in the art in light of the above teachings. Of course, those skilled in the art readily recognize that there are numerous applications of the disclosure beyond those described herein. While the disclosure has been described with reference to one or more particular embodiments, those skilled in the art recognize that many changes may be made thereto without departing from the scope of the disclosure. It is therefore to be understood that within the scope of the appended claims and their equivalents, the disclosure may be practiced otherwise than as specifically described herein.

1. A power converter arrangement for converting an alternating current (AC) voltage into a direct current (DC) voltage, the power converter arrangement comprising:
an AC-DC conversion stage being configured to convert an AC voltage into a first DC link voltage at a first DC link and into a second DC link voltage at a second DC link;
a DC-DC conversion stage connected to the AC-DC conversion stage, the DC-DC conversion stage being configured to provide the DC voltage based on the first DC link voltage and the second DC link voltage; and
a partial-power DC-DC converter coupled between the AC-DC conversion stage and the DC-DC conversion stage, the partial-power DC-DC converter being configured to exchange power between the first DC link and the second DC link.

2. The power converter arrangement of claim 1,
wherein the partial-power DC-DC converter is configured to regulate a value of the second DC link voltage so that an equivalent DC link voltage is proportional to a predetermined value of the DC voltage,
wherein the equivalent DC link voltage corresponds to a half of a sum of a value of the first DC link voltage and the value of the second DC link voltage.

3. The power converter arrangement of claim 2,
wherein the DC-DC conversion stage comprises a transformer having a Turns Ratio;
wherein the value of the DC voltage corresponds to the equivalent DC link voltage divided by the Turns Ratio of the transformer.

4. The power converter arrangement of claim 1,
wherein the DC-DC conversion stage comprises a Series Resonant Converter configured to operate at a fixed switching frequency equal to its resonant frequency.

5. The power converter arrangement of claim 1,
wherein the AC-DC conversion stage comprises a first port for providing the first DC link voltage and a second port for providing the second DC link voltage;
wherein the DC-DC conversion stage comprises a first port directly connected to the first port of the AC-DC conversion stage, and a second port directly connected to the second port of the AC-DC conversion stage.

6. The power converter arrangement of claim 5,
wherein the DC-DC conversion stage comprises a third port for providing the DC voltage,
wherein the third port of the DC-DC conversion stage is galvanically isolated from the first port and the second port of the DC-DC conversion stage.

7. The power converter arrangement of claim 5,
wherein the partial-power DC-DC converter is configured to process a power difference between a first average power and a second average power,
the first average power being a power provided by the AC-DC conversion stage to one of the first or second ports of the AC-DC conversion stage, and
the second average power being a power demanded by the DC-DC conversion stage from the respective port of the AC-DC conversion stage.

8. The power converter arrangement of claim 5,
wherein the partial-power DC-DC converter comprises a first port connected to the first port of the AC-DC conversion stage and the first port of the DC-DC conversion stage; and
wherein the partial-power DC-DC converter comprises a second port connected to the second port of the AC-DC conversion stage and the second port of the DC-DC conversion stage.

9. The power converter arrangement of claim 8, comprising:
a reference node providing a common reference potential,
wherein the first port and the second port of the AC-DC conversion stage are coupled to the reference node;
wherein the first port and the second port of the DC-DC conversion stage are coupled to the reference node; and
wherein the first port and the second port of the partial-power DC-DC converter are coupled to the reference node.

10. The power converter arrangement of claim 9, comprising:
a first capacitor coupled between the first port of the AC-DC conversion stage and the reference node, wherein the first DC link voltage corresponds to a voltage across the first capacitor; and
a second capacitor coupled between the second port of the AC-DC conversion stage and the reference node, wherein the second DC link voltage corresponds to a voltage across the second capacitor.

11. The power converter arrangement of claim 9, comprising:
a first capacitor coupled between the first port and the second port of the AC-DC conversion stage, wherein the first DC link voltage corresponds to a voltage across the first capacitor; and
a second capacitor coupled between the second port of the AC-DC conversion stage and the reference node, wherein the second DC link voltage corresponds to a voltage across the second capacitor.

12. The power converter arrangement of claim 9, wherein the DC-DC conversion stage comprises:
a full-bridge inverter, the full-bridge inverter comprising a first inverter leg connected between the first port of the AC-DC conversion stage and the reference node, and a second inverter leg connected between the second port of the AC-DC conversion stage and the reference node.

13. An automotive battery charging device comprising a power converter arrangement for converting an alternating current (AC) voltage into a direct current (DC) voltage, the power converter arrangement comprising:
an AC-DC conversion stage being configured to convert an AC voltage into a first DC link voltage at a first DC link and into a second DC link voltage at a second DC link;
a DC-DC conversion stage connected to the AC-DC conversion stage, the DC-DC conversion stage being configured to provide the DC voltage based on the first DC link voltage and the second DC link voltage; and
a partial-power DC-DC converter coupled between the AC-DC conversion stage and the DC-DC conversion stage, the partial-power DC-DC converter being configured to exchange power between the first DC link and the second DC link.

14. A method for converting an alternating current (AC) voltage into a direct current (DC) voltage, the method comprising:
converting an AC voltage into a first DC link voltage at a first DC link and into a second DC link voltage at a second DC link, by an AC-DC conversion stage;
providing a DC voltage, by a DC-DC conversion stage, based on the first DC link voltage and the second DC link voltage; and
exchanging power between the first DC link and the second DC link by a partial-power DC-DC converter, coupled between the AC-DC conversion stage and the DC-DC conversion stage.

15. The method of claim 14, further comprising,
regulating a value of the second DC link voltage so that an equivalent DC link voltage is proportional to a predetermined value of the DC voltage by the partial-power DC-DC converter,
wherein the equivalent DC link voltage corresponds to a half of a sum of a value of the first DC link voltage and the value of the second DC link voltage.

16. The method of claim 15, further comprising,
dividing the value of the DC voltage corresponds to the equivalent DC link voltage by a Turns Ratio of a transformer,
wherein the DC-DC conversion stage comprises the transformer having the Turns Ratio.

17. The method of claim 14, further comprising,
operating at a fixed switching frequency equal by a Series Resonant Converter to its resonant frequency which consists of the DC-DC conversion stage.

18. The method of claim 14, further comprising,
providing the first DC link voltage by a first port and providing the second DC link voltage by a second port;
wherein the AC-DC conversion stage comprises the first port and the second port;
wherein the DC-DC conversion stage comprises a first port directly connected to the first port of the AC-DC conversion stage, and a second port directly connected to the second port of the AC-DC conversion stage.

19. The method of claim 18, further comprising,
providing the DC voltage is provided by a third port which consists of the DC-DC conversion stage,
wherein the third port of the DC-DC conversion stage is galvanically isolated from the first port and the second port of the DC-DC conversion stage.

20. The method of claim 18, further comprising,
processing a power difference between a first average power and a second average power by the partial-power DC-DC converter,
the first average power being a power provided by the AC-DC conversion stage to one of the first or second ports of the AC-DC conversion stage, and
the second average power being a power demanded by the DC-DC conversion stage from the respective port of the AC-DC conversion stage.
